(19) United States
(12) Patent Application Publication
(10) Pub. No.: US 2024/0052508 A1
(43) Pub. Date: Feb. 15, 2024

(54) SEPARATOR PLATE COMPRISING INDIVIDUAL PLATES WHICH ARE NESTED IN EACH OTHER

(71) Applicant: Reinz-Dichtungs-GmbH, Neu-Ulm (DE)

(72) Inventors: André SPEIDEL, Bussmanshausen (DE); Bernd GAUGLER, Ulm (DE); Stephan WENZEL, Pfaffenhofen (DE)

(21) Appl. No.: 18/447,192

(22) Filed: Aug. 9, 2023

(30) Foreign Application Priority Data
Aug. 11, 2022 (DE) 20 2022 104 571.2

(51) Int. Cl. C25B 13/02; H01M 8/0258; H01M 8/18

(52) U.S. Cl. CPC C25B 13/02; H01M 8/0258; H01M 8/188

(57) ABSTRACT

The present disclosure relates to a separator plate for an electrochemical system, comprising a first individual plate and a second individual plate connected to the first individual plate, wherein channels of the individual plates are nested in each other. The present disclosure also relates to an arrangement for an electrochemical system, comprising a plurality of separator plates.

### CROSS-REFERENCE TO RELATED APPLICATION

The present application claims priority to German Utility Model Application No. 20 2022 104 571.2, entitled “SEPARATOR PLATE COMPRISING INDIVIDUAL PLATES WHICH ARE NESTED IN EACH OTHER”, and filed Aug. 11, 2022. The entire contents of the above-listed application is hereby incorporated by reference for all purposes.

### TECHNICAL FIELD

The present disclosure relates to a separator plate for an electrochemical system, comprising a first individual plate and a second individual plate connected to the first individual plate, wherein channels of the individual plates are nested in each other. The present disclosure also relates to an arrangement for an electrochemical system, comprising a plurality of separator plates.

### BACKGROUND AND SUMMARY

Known electrochemical systems usually comprise a stack of electrochemical cells, which are separated from each other by separator plates, wherein the separator plates, or at least an individual plate on each side of a separator plate, depending on the point of view, can also be regarded as part of the cell. Such separator plates may serve, for example, for indirectly electrically contacting the electrodes of the individual electrochemical cells (for example fuel cells) and/or for electrically connecting adjacent cells (series connection of the cells). The separator plates are typically formed of two individual plates which are joined together. The individual plates of the separator plate may be joined together in a materially bonded manner, for example by welding, laser welding, adhesive, gluing, or brazing.

The separator plates or the individual plates may each have or form channel structures, which are designed, for example, to supply one or more media to the electrochemical cells bounded by adjacent separator plates and/or to transport reaction products away therefrom. The media may be fuels (for example hydrogen or methanol) or reaction gases (for example air or oxygen). Furthermore, the separator plates or the individual plates may have structures for guiding a cooling medium through the separator plate, such as for guiding a cooling medium through a cavity enclosed by the individual plates of the separator plate, said cavity sometimes also being referred to as a coolant chamber. The separator plates may also be designed to transfer the waste heat that is generated when converting electrical or chemical energy in the electrochemical cell, and to seal off the various media channels and/or cooling channels with respect to each other and/or with respect to the outside.

Furthermore, the separator plates usually each have at least one or more through-openings. Through the through-openings, the media and/or the reaction products can be fed to the electrochemical cells bounded by adjacent separator plates of the stack, or into the cavity formed by the individual plates of the separator plate, or can be discharged from the cells or from the cavity. The electrochemical cells typically also comprise one or more membrane electrode assemblies (MEAs). The MEAs may have one or more gas diffusion layers, which are usually oriented towards the separator plates and are formed, for example, as a metal or carbon fleece.

In order to connect the individual plates to each other in a materially bonded manner, for example welding, laser welding, adhesive, gluing, or brazin, and form the separator plate, flat regions of the channel structures of the individual plates are often welded to each other. For example, the channel bottoms of the channel structures of the individual plates can be used for this, which are brought into contact with each other on their rear sides in order to connect them to each other. The flat regions of the channel bottoms sometimes require small radii of curvature at the adjoining channel bottom corners, which, however, are not optimal for the flow of media along the separator plate and also for manufacture of the plates and are difficult to implement. Small radii in the corner regions of the channels may additionally have the disadvantage that cracks form more quickly in the plates during use or even already during manufacture of the plates, thereby damaging the separator plate and in some circumstances possibly even causing the system to fail.

There is therefore a constant need, for instance with regard to mass production, to simplify manufacture of the separator plates.

Furthermore, separator plates for continuous use in electrochemical systems should have a long service life.

Additionally, in mobile applications for the electrochemical system, for example in fuel cell systems used in the transport sector, it would be desirable to keep the weight low and the installation space small for the separator plates and the electrochemical system as a whole, or to further reduce these in relation to known systems. In addition, it would be desirable to improve the cold-start behavior of these systems.

The present disclosure has been designed to solve the above-mentioned problems at least in part.

According to a first aspect of the present disclosure, a separator plate for an electrochemical system is provided. The separator plate comprises a first individual plate and a second individual plate connected to the first individual plate.

The first individual plate has first channels for guiding media, which first channels are integrally formed in the first individual plate, extend next to each other, and are separated from each other by first webs formed between the first channels. The first channels form an open side and first elevations on a side of the first individual plate that is located opposite the open side, wherein the first webs form first grooves on the side of the first individual plate that is located opposite the open side of the first channels.

The second individual plate has second channels for guiding media, which second channels are integrally formed in the second individual plate, extend next to each other, and are separated from each other by second webs formed between the second channels,

wherein the second channels form an open side and second elevations on a side of the second individual plate that is located opposite the open side, wherein the second webs form second grooves on the side of the second individual plate that is located opposite the open side of the second channels.

It is further provided that the first channels and the second channels each have a wave-like course at least in part along the direction of extension thereof, wherein the wave-like course of the first channels is offset substantially by x−½ (x minus one half) periods in relation to the wave-like course of the second channels, so that the wave shapes of the first channels and of the second channels run inversely. Here, x is a natural number greater than 0, e.g. 1, 2, 3, 4, 5, 6 . . . , n. The period offset is therefore, for example, 0.5; 1.5; 2.5; 3.5; 4.5; n−0.5. Thus, 1½ periods are possible, which is nevertheless perceived locally as a ½ period offset with a correspondingly longer straight run-in or run-out. The wave shape is not restricted to a sinusoidal wave. Waves with trapezoidal or triangular basic shapes are also possible, as are rounded hybrid forms of the aforementioned shapes.

Projections of the first channels onto the second individual plate perpendicular to a flat surface plane of the second individual plate cross the second channels along a plurality of crossing regions. The first channels have, in the crossing regions, raised channel bottom portions which are designed to receive the second elevations of the second channels. In addition, the first channels have channel bottom depressions so that the first elevations partially engage in the second grooves of the second individual plate. The channel bottom depressions may be provided outside of the crossing regions of the first and second channels.

The separator plate is designed in such a way that the first elevations and the second grooves are nested in each other and/or the first grooves and the second elevations are nested in each other, the two individual plates engage in each other and bear against each other at least at one side.

By virtue of the proposed separator plate, various effects and/or advantages can be achieved, which will be explained in greater detail below.

Due to the fact that the two individual plates engage in each other, instead of resting against each other as in the prior art, an intermediate space defined by the individual plates can be reduced in size. If the intermediate space is designed as a coolant chamber, and the individual plates thus bound a coolant chamber, the amount of cooling fluid can thereby be reduced, which can result in a more agile cold-start behavior and also a reduction in weight.

Usually, therefore, a coolant chamber for receiving and conducting a cooling fluid is formed between the individual plates. Optionally, the first grooves and the second grooves are designed to guide the cooling fluid along the separator plate. It may be provided that adjacent first grooves and/or adjacent second grooves are fluidically connected to each other via the raised channel bottom portions in the crossing regions. By fluidically connecting the grooves, the cooling fluid can be better distributed over the grooves, as a result of which a more uniform cooling effect can be achieved.

Often, the two individual plates engage in each other with a form fit. It may be provided that the form fit acts parallel to the flat surface planes of the individual plates and prevents any displacement of the individual plates parallel to the flat surface planes. In addition to the form fit, the individual plates may also be connected to each other with a force fit. In some embodiments, the two individual plates bear against each other at least at two sides, thereby preventing any displacement of the individual plates relative to each other in at least two directions, for instance parallel to the flat surface planes. For instance, on account of the tolerances, bearing at two sides does not necessarily mean that channels which engage in each other do so at both flanks in a single cross-section; instead, for instance if one channel, in its course, engages in channels of the other individual plate in such a way that in a first portion, such as a given wave period, it bears on the right against the channel of the other individual plate, and in another portion, for instance in a portion offset by n−½ periods, it bears on the left against another channel of the other individual plate. In some embodiments, therefore, a materially bonded connection can be omitted at least in the region of the first channels and the second channels, but a materially bonded connection would still be possible at the crossing points due to the geometric conditions there. As mentioned above, the material bonding may comprise welding, laser welding, adhesive, gluing, or brazing. The separator plate as a whole can be stiffened as a result of the described form fit and the locking between the individual plates. The rear sides of the channels of the individual plates can therefore be supported against each other, which can result in a homogenized distribution of forces and has a stabilizing effect on the separator plate. Therefore, in the region of the first channels and the second channels, the individual plates may be connected to each other only with a form fit and/or force fit, and for instance not in a materially bonded manner.

The two individual plates usually touch each other at contact areas. Optionally, at least one of the individual plates, in the region of the contact areas, is partially laser surface-treated or has a coating to improve the electrical conductivity. With regard to possible embodiments of the laser surface treatment, reference is made, for example, to the publication DE 10 2021 202 214 A1, the content of which is hereby fully incorporated in the present specification by way of reference. With regard to possible coatings, reference is made to the publications DE 10 2004 009 869 A1 and WO 2021/028399 A1, the content of which is hereby fully incorporated in the present specification by way of reference. The coating method of the last-mentioned document may also be combined with pre-treatment methods other than etching, such as sputtering for example. Conventional individual plates are often connected to each other by means of a welded joint, not only for mechanical connection, but also to improve or establish electrical contacting between the two plates. Since the individual plates of the separator plate of the present disclosure can already be connected to each other with a form fit, and sufficient electrical contacting can be ensured by the coating or the laser surface treatment, the materially bonded connection, for example the welded joint, can be omitted at least in this region of the separator plate. Without prejudice to this, it may be necessary to provide sealing connections, such as materially bonded connections, such as weld lines or adhesive bonds, in other regions, for instance all the way around the outer edge and at least partially around the through-openings.

The first channels often extend at least in part parallel to each other. As an alternative or in addition, the second channels may extend at least in part parallel to each other. The first channels and the second channels may have main directions of extension which are oriented parallel to the respective flat surface plane and parallel to each other. Here, the main direction of extension describes the direction in which the respective channel runs, without taking into account the lateral deviations/deflections of the wave shape in the transverse direction. A wave shape is thus superimposed on the main direction of extension of the first channels and second channels.

A wave shape can generally be defined by a wavelength, a phase and an amplitude. In the portion where the channels cross, therefore, the wave shape of the first channels and the wave shape of the second channels may each have the same wavelength and the same amplitude, but a phase that differs by half a wavelength. Nevertheless, it is possible that the amplitude in one individual plate is a multiple (integer multiple) of the amplitude in the other individual plate, for instance two times the latter. Here, the amplitude is measured in the transverse direction, while the main direction of extension of the channels extends in the longitudinal direction of the channels. In the longitudinal course, e.g. in the main direction of extension of the channels, regions having different wave shapes are possible one behind the other, which may immediately follow each other or may be separated from each other by a portion of the channels that has no deflection in the transverse direction.

It may be provided that the first channels and/or the second channels have a bent and/or curved cross-section, for example a circular or semi-circular cross-section, over at least part of their cross-section. The first channels and/or the second channels are often curved at least in part, for example at least in the region of their side walls, in a cross-section transverse to the wave-like course. The channel bottom as such may be flat, e.g. parallel to the plate plane, or may also be curved. Side walls of the channels may have curvatures at least in part. For example, a radius of curvature in the region of the channel bottoms of the first channels and/or second channels may have a value which, at the relevant cross-section, corresponds to at least half of the channel width at the height that forms half of the maximum extension between the channel bottom inner side and the web surface. This design can prevent angular corners or small radii of curvature in the region of the channel bottoms, thereby simplifying manufacture of the individual plates, such as the shaping of the individual plates to form the channels, and extending the service life of the separator plate. Web tops of the first webs and/or second webs typically extend in a substantially flat manner, for example parallel to the flat surface plane of the respective individual plate.

In conventional separator plates, the height of the separator plates is composed of the sum of the material thicknesses and twice the maximum channel bottom depth. Since the first elevations and the second grooves are nested in each other and the two individual plates engage in each other, a height of the separator plate measured perpendicular to a flat surface plane of the separator plate may be less than the sum of the material thicknesses of the two individual plates and twice the maximum channel bottom depth. Here, the channel bottom depth is measured from the channel bottom to the flat surface plane of the plate, e.g. at a location where the plate is not deformed. The separator plate can therefore be made more compact than conventional separator plates. In addition, the cavity defined by the individual plates can thus be reduced in size. This also leads to a reduction in weight of the separator plate when the separator plate is used as intended in the electrochemical system, since overall less cooling medium flows through the smaller coolant chamber.

A channel bottom depth of the first channels usually varies between the raised channel bottom portions, at which the channel depth is smallest, and the channel bottom depressions, at which the channel depth is greatest. The relative height of the raised channel bottom portion may be, for example, 10% to 50% of the maximum channel depth. The absolute height of the separator plate usually depends on the use case. For fuel cells, the height may be at most 1.2 mm, for example at most 0.6 mm.

The first channels and the second channels are usually arranged in an electrochemically active region of the separator plate. Typically, adjacent separator plates in a separator plate stack bound an electrochemical cell. The electrochemical processes, such as, for example, the conversion of chemical energy into electrical energy, or vice versa, usually take place in the electrochemically active region of the electrochemical cell. The first webs and the second webs often form bearing surfaces for a membrane electrode assembly (MEA), for instance the gas diffusion layer (GDL) thereof. The MEA and the GDL(s) thereof are usually arranged between the adjacent separator plates.

The first individual plate and the second individual plate may each have a plate body made of a metal, wherein the first channels and the second channels or the first elevations and the second elevations are integrally formed in the respective plate body, such as by embossing. The integral forming may take place by means of hydroforming, deep-drawing or embossing, such as roller embossing or vertical embossing. One manufacturing technique that delivers high embossing performance with little application of force, in order to form the channel structures of the individual plates, is roller embossing, for example. With the relatively large radii of curvature proposed here, the separator plate may be manufactured easily by means of roller embossing.

It may be provided that the separator plate is at least in part rotationally symmetrical through 180° in the flat surface plane of the separator plate. For instance, the rotational symmetry is given at least with regard to the periphery of the separator plate, e.g. the media ports, the outer seal and essential parts of the distribution region. In contrast, the electrochemically active region may also not be rotationally symmetrical.

According to another aspect, an arrangement for an electrochemical system is proposed. The arrangement comprises a plurality of separator plates of the type described above. In one embodiment of the arrangement, adjacent separator plates are rotated through 180° relative to each other, such as if the separator plates are at least in part rotationally symmetrical through 180°. As a result, wave shapes of stacked separator plates located one above the other can be offset from each other, which can lead to a better distribution of forces in the stack. On the other hand, in the case of separator plates which are additionally mirror-symmetrical in the flow field (electrochemically active region), it is possible to rotate these separator plates through 180° such that the channels and webs in individual plates arranged closest to each other, e.g. on each side of the same MEA, have wave shapes running in phase, which may lead to the MEA being well-supported due to the linear contact.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows, in a perspective view, an electrochemical system comprising a plurality of separator plates arranged in a stack.

FIG. 2 schematically shows, in a perspective view, two separator plates of the system according to FIG. 1 with a membrane electrode assembly (MEA) arranged between the separator plates.

FIG. 3 schematically shows a section through a plate stack of a system of the same type as the system shown in FIG. 1.

FIG. 4A schematically shows a perspective view of media-guiding channels of a separator plate.

FIG. 4B schematically shows a plan view of the channels of the separator plate of FIG. 4A, the channels on the rear side of the separator plate also having been made visible.

FIGS. 4C-4E schematically show various sectional views through the separator plate of FIGS. 4A, 4B.

FIG. 5A schematically shows a perspective view of media-guiding channels of a further separator plate.

FIG. 5B schematically shows a plan view of the channels of the separator plate of FIG. 5A, the channels on the rear side of the separator plate also having been made visible.

FIGS. 5C-5E schematically show various sectional views through the separator plate of FIGS. 5A, 5B.

FIG. 6A schematically shows a perspective view of media-guiding channels of a further separator plate, the channels on the rear side of the separator plate also having been made visible.

FIGS. 6B-6D schematically show various sectional views through the separator plate of FIG. 6A.

### DETAILED DESCRIPTION

Here and below, features that recur in different figures are denoted in each case by the same or similar reference signs.

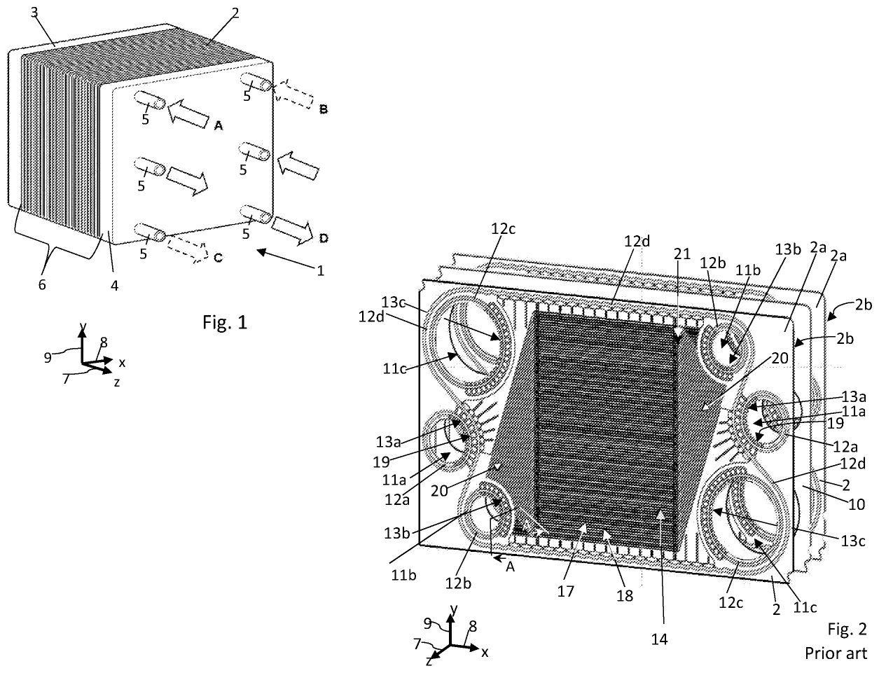

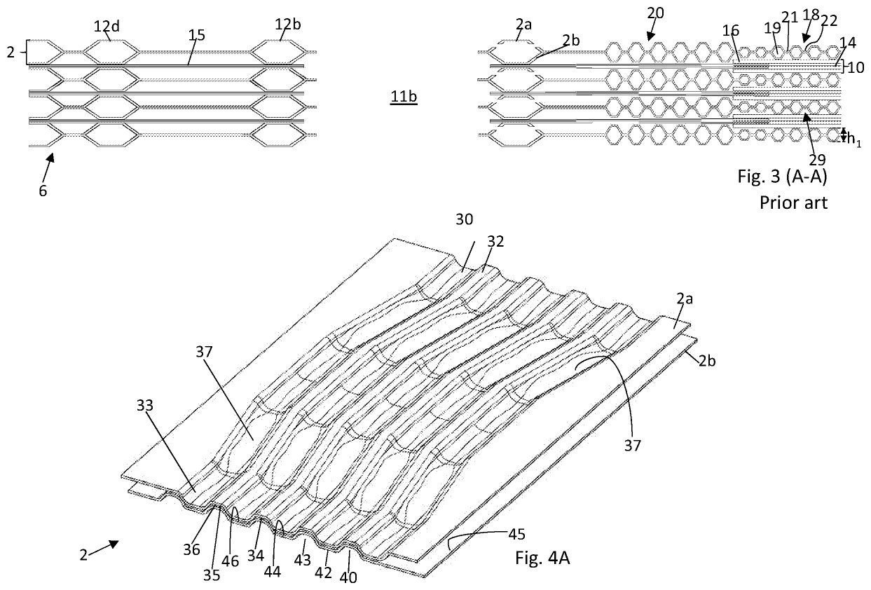

FIG. 1 shows an electrochemical system 1 comprising a plurality of structurally identical metal separator plates 2, which are arranged in a stack 6 and are stacked along a z-direction 7. The separator plates 2 of the stack 6 are clamped between two end plates 3, 4. The z-direction 7 is also referred to as the stacking direction. In the present example, the system 1 is a fuel cell stack. Each two adjacent separator plates 2 of the stack bound an electrochemical cell, which serves, for example, to convert chemical energy into electrical energy. To form the electrochemical cells of the system 1, a membrane electrode assembly (MEA) is arranged in each case between adjacent separator plates 2 of the stack (see, for example, FIG. 2). Each MEA typically contains at least one membrane, for example an electrolyte membrane. Furthermore, a gas diffusion layer (GDL) (not shown in FIGS. 1 and 2) may be arranged on one or both surfaces of the MEA.

In alternative embodiments, the system 1 may also be designed as an electrolyzer, as an electrochemical compressor, or as a redox flow battery. Separator plates can likewise be used in these electrochemical systems. The structure of these separator plates may then correspond to the structure of the separator plates 2 explained in detail here, although the media guided on and/or through the separator plates in the case of an electrolyzer, an electrochemical compressor or a redox flow battery may differ in each case from the media used for a fuel cell system.

The z-axis 7, together with an x-axis 8 and a y-axis 9, spans a right-handed Cartesian coordinate system. The separator plates 2 each define a plate plane, hereinafter also referred to as the flat surface plane, each of the plate planes of the individual plates being oriented parallel to the x-y plane and thus perpendicular to the stacking direction or to the z-axis 7. The end plate 4 has a plurality of media ports 5, via which media can be supplied to the system 1 and via which media can be discharged from the system 1. Said media that can be supplied to the system 1 and discharged from the system 1 may include, for example, fuels such as molecular hydrogen or methanol, reaction gases such as air or oxygen, reaction products such as water vapor or depleted fuels, or coolants such as water and/or glycol.

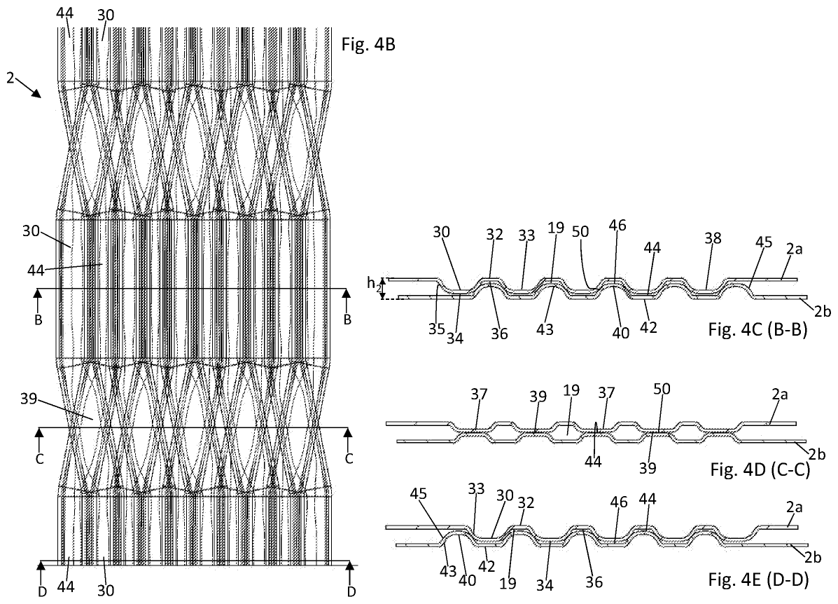

FIG. 2 shows, in a perspective view, two adjacent separator plates 2 of an electrochemical system of the same type as the system 1 from FIG. 1, as well as a membrane electrode assembly (MEA) 10, known from the prior art, which is arranged between these adjacent separator plates 2, the MEA 10 in FIG. 2 being largely obscured by the bipolar plate 2 facing towards the viewer. The bipolar plate 2 is formed of two individual plates 2a, 2b which are joined together in a materially bonded manner (see, for example, FIG. 3), of which only the first individual plate 2a facing towards the viewer is visible in FIG. 2, said first individual plate obscuring the second individual plate 2b. The individual plates 2a, 2b may each be manufactured from a metal sheet, for example from a stainless-steel sheet. The individual plates 2a, 2b may for example be welded to each other, for example by laser-welded joints.

The individual plates 2a, 2b have through-openings, which are aligned with one another and form through-openings 11a-c of the bipolar plate 2. When a plurality of separator plates of the same type as the bipolar plate 2 are stacked, the through-openings 11a-c form lines which extend through the stack 6 in the stacking direction 7 (see FIG. 1). Typically, each of the lines formed by the through-openings 11a-c is fluidically connected to one of the media ports 5 in the end plate 4 of the system 1. For example, coolant can be introduced into the stack or discharged from the stack via the lines formed by the through-openings 11a. In contrast, the lines formed by the through-openings 11b, 11c may be designed to supply fuel and reaction gas to the electrochemical cells of the fuel cell stack 6 of the system 1 and to discharge the reaction products from the stack. The media-guiding through-openings 11a-11c are substantially parallel to the plate plane.

In order to seal off the through-openings 11a-c with respect to the interior of the stack 6 and with respect to the surrounding environment, the first individual plates 2a may each have sealing arrangements in the form of sealing beads 12a-c, which are arranged in each case around the through-openings 11a-c and in each case completely surround the through-openings 11a-c. On the rear side of the separator plates 2, facing away from the viewer of FIG. 2, the second individual plates 2b have corresponding sealing beads for sealing off the through-openings 11a-c (not shown).

In an electrochemically active region 18, the first individual plates 2a have, on the front side thereof facing towards the viewer of FIG. 2, a flow field 17 with structures for guiding a reaction medium along the front side of the individual plate 2a. In FIG. 2, these structures are defined by a plurality of webs and by channels extending between the webs and delimited by the webs. On the front side of the separator plates 2, facing towards the viewer of FIG. 2, the first individual plates 2a additionally each have at least one distribution or collection region 20. A distribution or collection region 20 comprises structures which are designed to distribute over the active region 18 a medium that is introduced into the distribution or collection region 20 from a first of the two through-openings 11b and to collect or to pool a medium flowing from the active region 18 towards the second of the through-openings 11b. In FIG. 2, the structures of the distribution or collection region 20 are likewise defined by webs and by channels extending between the webs and delimited by the webs. In general, the elements 17, 18, 20 can therefore be interpreted as media-guiding embossed structures.

The sealing beads 12a-12c have passages 13a-13c, which here are in the form of local depressions or perforations in the bead and enable medium to pass across the respective sealing bead, e.g. to and from the active region.

The first individual plates 2a each also have a further sealing arrangement in the form of a perimeter bead 12d, which extends around the flow field 17 of the active region 18 and also around the distribution or collection regions 20 and the through-openings 11b, 11c and seals these off with respect to the through-opening 11a, that is to say with respect to the coolant circuit, and with respect to the environment surrounding the system 1. The second individual plates 2b each comprise corresponding perimeter beads. The structures of the active region 18, the distributing structures of the distribution or collection region 20 and the sealing beads 12a-d are each formed in one piece with the individual plates 2a and are integrally formed in the individual plates 2a, for example in an embossing or deep-drawing process. The same applies to the corresponding distributing structures and sealing beads of the second individual plates 2b. Instead of the sealing beads, elastomeric sealing elements could also be used, for example elastomeric sealing elements applied by injection or placement.

The two through-openings 11b or the lines through the plate stack of the system 1 that are formed by the through-openings 11b are in each case fluidically connected to each other via passages 13b in the sealing beads 12b, via the distributing structures of the distribution or collection region 20 and via the flow field 17 in the active region 18 of the first individual plates 2a facing towards the viewer of FIG. 2. Analogously, the two through-openings 11c or the lines through the plate stack of the system 1 that are formed by the through-openings 11c are in each case fluidically connected to each other via corresponding bead passages, via corresponding distributing structures and via a corresponding flow field on an outer side of the second individual plates 2b facing away from the viewer of FIG. 2. In contrast, the through-openings 11a or the lines through the plate stack of the system 1 that are formed by the through-openings 11a are in each case fluidically connected to each other via a cavity 19 which is surrounded or enclosed by the individual plates 2a, 2b. This cavity 19, hereinafter also referred to as the coolant chamber 19, serves in each case to guide a coolant through the separator plate 2, such as for cooling the electrochemically active region 18 of the separator plate 2.

FIG. 3 schematically shows a section through a portion of the plate stack 6 of the system 1 from FIG. 1, wherein the sectional plane is oriented in the z-direction and thus perpendicular to the plate planes of the separator plates 2; it may extend, for example, along the stepped section A-A in FIG. 2.

The structurally identical separator plates 2 of the stack in each case comprise the above-described first metal individual plate 2a and the above-described second metal individual plate 2b. Structures for guiding media along the outer surfaces of the separator plates 2 can be seen, for example here in the form of webs and of channels delimited by the webs. It shows channels 29, which are located on the surfaces of adjacent individual plates 2a, 2b that face away from each other, and cooling channels in the cavity 19 between adjacent individual plates 2a, 2b. Between the cooling channels 19, the two individual plates 2a, 2b bear against each other in a contact area 21 and are connected to each other there, in the present example by means of laser welds.

A membrane electrode assembly (MEA) 10, known for example from the prior art, is arranged in each case between adjacent separator plates 2 of the stack. Each MEA 10 typically comprises a membrane 14, for example an electrolyte membrane, and an edge portion 15 connected to the membrane. By way of example, the edge portion 15 may be materially bonded to the membrane, for example by welding, laser welding, adhesive, gluing, brazing or by lamination.

The membrane of the MEA 10 extends in each case at least over the active region 18 of the adjacent separator plates 2 and enables a transfer of protons across or through the membrane at that point. However, the membrane does not extend into the distribution or collection region 20. The edge portion 15 of the MEA 10 serves to position, fasten and seal the membrane between the adjacent separator plates 2. When the separator plates 2 of the system 1 are clamped between the end plates 3, 4 in the stacking direction (see FIG. 1), the edge portion 15 of the MEA 10 can be compressed, for example, between the sealing beads 12a-d of the respectively adjacent separator plates 2 and/or at least between the perimeter beads 12d of the adjacent separator plates 2, in order thus to fix the membrane 14 of the MEA 10 between the adjacent separator plates 2.

Furthermore, gas diffusion layers 16 may additionally be arranged in the active region 18. The gas diffusion layers 16 enable a flow across the membrane over as large an area of the surface of the membrane as possible and can thus improve proton transfer through the membrane. The gas diffusion layers 16 may, for example, be arranged on both sides of the membrane in the active region 18 between the adjacent separator plates 2. The gas diffusion layers 16 may, for example, be formed of a fiber fleece or comprise a fiber fleece.

As already explained above, the individual plates 2a, 2b bear against each other in contact areas 21 and are often connected to each other there by means of welded joints 22. The materially bonded connection 22 in the active region 18 is intended to ensure that the channels do not move relative to each other and that no offset occurs between the channels. To create sufficient space for the contact areas 21 and the welded joints 22 that are to be formed there, the channel bottoms are usually designed as relatively large flat surfaces, but this often leads to relatively small radii of curvature in the area of transition to the channel walls. This in turn causes difficulties in manufacturing the individual plates 2a, 2b and requires a great deal of energy to implement. In addition, small radii of curvature lead to unfavorable flow conditions for the fluid flowing there.

A height h1 in the region of the active region 18 of the separator plate 2 is obtained by adding together the plate thickness of the individual plates 2a, 2b and the height of the individual plates 2a, 2b perpendicular to the plate plane. The height of the individual plates 2a, 2b, in the active region of the separator plate 2, is in turn given by a channel depth of the channels.

For mobile applications of the electrochemical system 1, it would be desirable if the installation space of the electrochemical system 1 or of the components thereof, for instance the separator plates 2, can be reduced, along with the weight of the electrochemical system 1, for instance of the cooling medium guided therein.

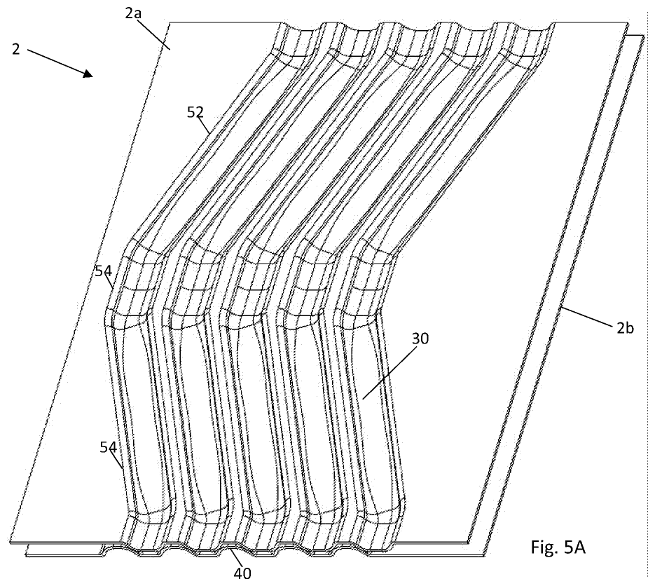

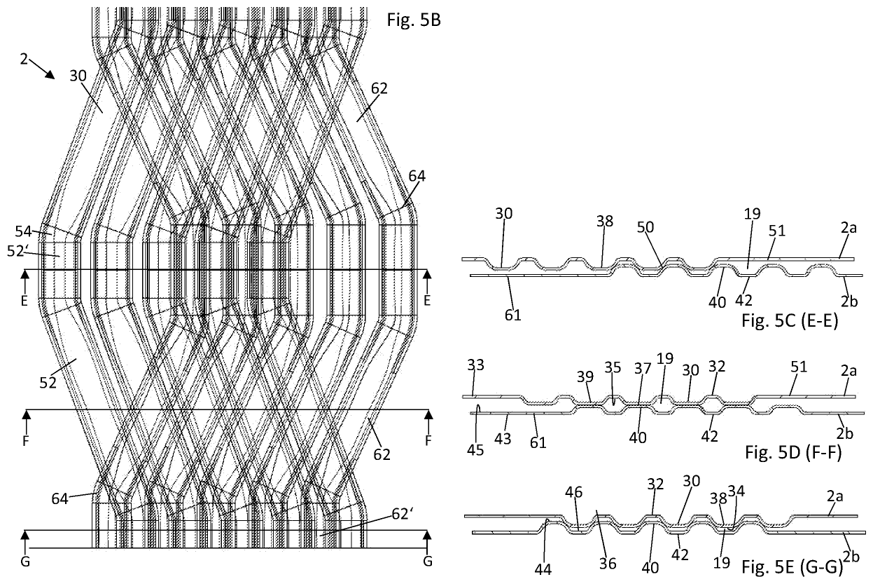

The present disclosure has been designed to solve the above problems at least in part. The present disclosure will be further explained with reference to FIGS. 4A-4E and 5A-5E.

FIGS. 4A-4E and 5A-5E show various views and cross-sections of a portion of a separator plate 2 in the region of the electrochemically active region 18 thereof. The separator plate 2 may be suitable for the electrochemical system 1 shown in FIG. 1 and comprises a first individual plate 2a and a second individual plate 2b connected to the first individual plate 2a. For reasons of clarity, FIGS. 4A-4E and 5A-5E show only a very small number of channels 30, 40 extending next to each other. The portions of the crossing channels 30, 40 in which these channels 30, 40 cross each other usually occupy a much larger surface area in a separator plate than the portions of these channels 30, 40 that do not cross over each other.

The first individual plate 2a has first channels 30 for guiding media, which first channels are integrally formed in the first individual plate 2a, extend next to each other, and are separated from each other by first webs 32 formed between the first channels 30.

The first channels 30 form an open side 33 and first elevations 34 on a side 35 of the first individual plate 2a that is located opposite the open side 33, wherein the first webs 32 form first grooves 36 on the side 35 of the first individual plate 2a that is located opposite the open side 33 of the first channels 30.

The second individual plate 2b has second channels 40 for guiding media, which second channels are integrally formed in the second individual plate 2b, extend next to each other, and are separated from each other by second webs 42 formed between the second channels 40. Furthermore, the second channels 40 form an open side 43 and second elevations 44 on a side 45 of the second individual plate 2b that is located opposite the open side 43, wherein the second webs 42 form second grooves 46 on the side 45 of the second individual plate 2b that is located opposite the open side 43 of the second channels 40.

The first channels 30 and the second channels 40 each have a wave-like course at least in part along the direction of extension thereof.

The wave-like course of the first channels 30 is offset substantially by x−½ periods in relation to the wave-like course of the second channels, x being a natural number greater than 0, so that the wave shapes of the first channels 30 and of the second channels 40 run inversely.

As shown in FIG. 4B, for example, projections of the first channels 30 onto the second individual plate 2b perpendicular to a flat surface plane of the second individual plate 2b cross the second channels 40 along a plurality of crossing regions 39.

The first channels 30 have, in the crossing regions, raised channel bottom portions 37 which are designed to receive the second elevations 44 of the second channels 40. In addition, the first channels 30 have channel bottom depressions 38 so that the first elevations 34 partially engage in the second grooves 46 of the second individual plate 2b. Overall, the first elevations 34 and the second grooves 46 are then nested in each other. Furthermore, the first grooves 36 and the second elevations 44 are nested in each other. In addition, the two individual plates 2a, 2b engage in each other, for example with a form fit, and bear against each other at least at one side. The channels 30, 40 therefore have a non-constant channel depth that varies between the raised channel bottom portions 37 and the channel bottom depressions 38.

Due to the measures described, the separator plate 2 has, at least in the active region 18, a separator plate height h2 which is less than the sum of the material thicknesses of the two individual plates 2a, 2b and the maximum channel bottom depths of the two individual plates 2a, 2b measured perpendicular to the plate plane of the respective individual plate 2a, 2b. The maximum channel bottom depth of the first channels 30 is given in the region of the channel bottom depressions 38. The separator plate height h2 is consequently smaller than the height h1 of a conventional separator plate 2 in the active region 18, resulting in a saving in terms of installation space. For example, the coolant chamber 19 defined between the individual plates 2a, 2b can be reduced in size, resulting in a reduction in cooling fluid and thus a reduction in the weight of a separator plate 2 filled with cooling fluid. The relative height of the raised channel bottom portion may be, for example, 10% to 50% of the maximum channel depth. The absolute height h2 of the separator plate 2 generally depends on the use case. For fuel cells, the height h2 may be at most 1.2 mm, for example at most 0.6 mm.

It can be seen in FIGS. 4A-4E and 5A-5E that the first channels 30 extend parallel to each other and that the second channels 40 extend parallel to each other. The wave shape of the channels 30, 40 is characterized by an amplitude measured in the transverse direction, a wavelength measured in the main direction of extension, and a period. The channels 30, 40 crossing over each other usually have the same amplitudes and the same wavelengths. However, the phases of the channels 30, 40 differ from each other, namely such that the channels 30, 40 run inversely, as described above. Therefore, when the first channels 30 deflect to the left, the second channels 40 deflect to the right, and vice versa. However, the main directions of extension of the channels 30, 40 are oriented parallel to each other and parallel to the flat surface plane of the respective individual plates 2a, 2b. FIGS. 4A-4E and 5A-5E show only a portion of the separator plate 2, as a result of which the channels 30, 40 only have a length of approximately one wavelength. The channels 30, 40 are of course usually longer than the wavelength shown.

The active region 18 may also contain portions in which the channels 30, 40 have a straight course or a wave-like course with a different amplitude or wavelength. The wavy, straight or otherwise shaped portions of the channels 30, 40 may, for example, be arranged one after the other. Similarly, straight channels at the side edge of the active region 18 may, for example, be arranged in the transverse direction next to waves that deflect to a small extent, with waves that deflect to a greater extent being adjacent thereto towards the middle of the separator plate 2. The waves that deflect to a greater extent may also be arranged at the side edge of the active region 18, with the waves that are straight or that deflect to a small extent being oriented towards the middle of the separator plate, since with this arrangement the locking effect may be effective.

The wave shape of the channels 30, 40 does not have to be strictly sinusoidal, as can be seen from FIGS. 5A-5E. In said figures, the channels 30, 40 have a zigzag course with straight channel portions 52, 52′, 62, 62′ and curved channel portions 54, 64, wherein the straight channel portions 52, 52′ 62, 62′ are connected to each other via the curved channel portions 54, 64. Overall, the wave shapes of the channels 30, 40 in FIGS. 5A-5E have a greater amplitude (deflection) than the wave shapes of the channels 30, 40 shown in FIGS. 4A-4E.

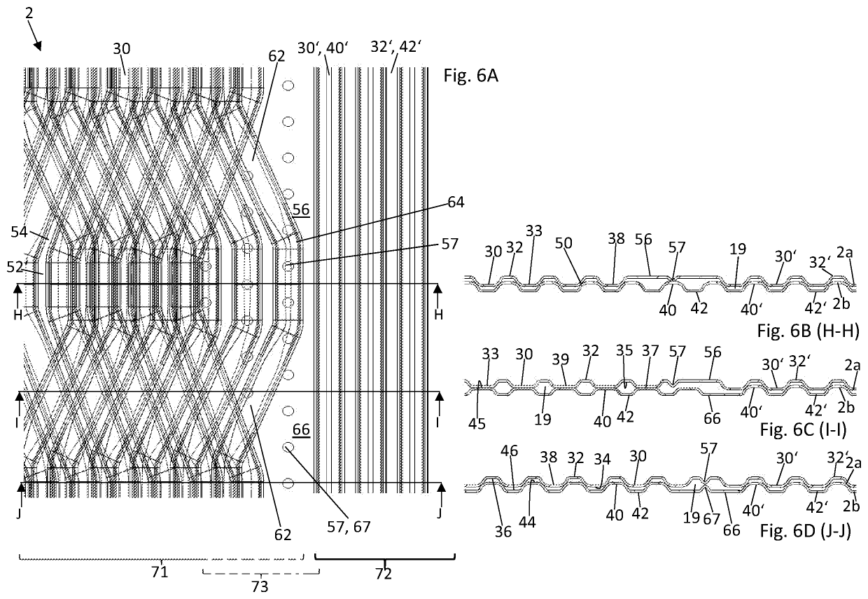

In certain regions of the separator plate 2, for instance at the peripheral edges of the electrochemically active region 18 or within the electrochemically active region 18 in transition regions between channels of different amplitude, it may happen that some of the channels 30, 40 of the individual plate 2a, 2b are in part not covered by channels 40, 30 of the other individual plate 2b, 2a, cf. for example FIGS. 5A-5E. In these regions of the other individual plate 2b, 2a, there may instead be, as shown, a relatively flat region 51, 61 which has no embossment or structuring. However, it is also possible to provide such edge regions or transition regions with additional supporting structures, which may, with respect to the main direction of extension of the channels, be designed as discrete structures. This is shown in FIGS. 6A-6D. Here, in the illustrated portion of the separator plate 2, channels 30, 40 and webs 32, 42 with crossing regions 39 are formed in the region 71 on the left, whereas rectilinear channels 30′, 40′ and rectilinear webs 32′, 42′ are integrally formed in the individual plates 2a, 2b of the separator plate 2 in the region 72 on the right. Between the region 71 on the left and the region 72 on the right, there is a region 73 in which channels 30 or 40 are formed in each case only in one individual plate 2a, 2b. The width of the regions 71 and 73 varies along the main direction of extension of the channels 30, 30′, 40, 40′, which is indicated by the dashed brackets. The region 71 on the left in FIG. 6A substantially corresponds to the structures as shown in FIGS. 5A-5E.

In the region 73, supporting structures or stiffening elements 57, 67 are integrally formed in the two individual plates 2a, 2b in the otherwise flat regions 56, 66. As is clear from the sectional views in FIGS. 6B-6D, the supporting structures 57 may rest against the rear side of a channel 40 (cf. FIG. 6B) or against a supporting structure 67 of the second individual plate (cf. FIG. 6D), so that the local contact ensures mutual support between the respective individual plates 2a, 2b and prevents any sinking of the region 73 that is not provided with channels in both individual plates 2a, 2b. However, such embossments may also be designed only as stiffening elements 57, without being in contact with the other individual plate 2b. These also stiffen the region 73.

Both the region 71 and the region 72 may each continue to the side. It is also possible that further regions analogous to the regions 72 and 73 are formed to the left of the region 71, so that the rectilinear channels 30′, 40′ are located in the edge regions of the electrochemically active region 18. Alternatively, it is possible that further regions analogous to the regions 71 and 73 are formed to the right of the region 72, so that the wave-like channels 30, 40 are located in the edge regions of the electrochemically active region 18.

As already indicated above, the individual plates 2a, 2b are connected to each other in the region of the channels 30, 40 for instance with a form fit. In this case, it may be provided that the form fit acts parallel to the flat surface planes of the individual plates 2a, 2b and prevents any displacement of the individual plates 2a, 2b parallel to the flat surface planes. In the variants of FIGS. 4 and 5, the two individual plates 2a, 2b bear against each other at least at two sides, thereby preventing any displacement of the individual plates 2a, 2b relative to each other in at least two directions. The channels 30, 40 therefore have a self-centering or self-locking effect, as a result of which the channels 30, 40 are automatically aligned with each other during the joining process. The separator plate 2 is also stiffened as a result, thereby stabilizing the separator plate 2. Welded joints 22 or other materially bonded connections can be omitted altogether in the active region 18.

In conventional separator plates 2, the welded joints 22 often also have the function of electrically contacting the individual plates 2a, 2b. To improve the electrical contact between the individual plates 2a, 2b, it may optionally be provided that at least one of the individual plates 2a, 2b has in some regions, for instance in the contact areas 21 and/or in the region of the contact areas 50, a coating such as a PVD (physical vapor deposition) coating or a laser surface treatment to improve the electrical conductivity. Reference may be made to DE 10 2021 202 214 A1 for further details regarding the laser surface treatment and to DE 10 2004 009 869 A1 and WO 2021/028399 A1 for further details regarding the coating, wherein, in the latter case, use can also be made of surface pre-treatments other than etching, such as sputtering for example.

The cavity or coolant chamber 19 formed between the individual plates 2a, 2b is thus usually formed to receive and conduct the cooling fluid. Generally, the first grooves 36 and the second grooves 46 are designed to guide the cooling fluid along the separator plate 2. It may be provided that adjacent first grooves 36 and/or adjacent second grooves 46 are fluidically connected to each other via the raised channel bottom portions 37 in the crossing regions 39. By fluidically connecting the grooves 36, 46, the cooling fluid can be better distributed over the grooves 36, 46, as a result of which a more uniform cooling effect can also be achieved.

It may be provided that the channels 30, 40 have at least in part a bent and/or curved cross-section, for example a circular or semi-circular cross-section. For instance, in the sectional views of FIGS. 4C, 4E, 5C and 5E, it can be seen that the first and second channels 30, 40 have such a cross-section at least in the regions in which these channels 30, 40 are nested in each other. In this case, the channels 30, 40 may be curved at least in part, for example at least in the region of their side walls, in a cross-section transverse to the wave-like course. The channel bottoms of the channels 30, 40 as such may be flat, e.g. parallel to the plate plane, or may also be curved. Side walls of the channels may have curvatures at least in part. For example, a radius of curvature in the region of the channel bottoms of the first channels and/or second channels may have a value which, at the relevant cross-section, corresponds to at least half of the channel width at the height that forms half of the maximum extension between the channel bottom inner side and the web surface.

The first channels 30 and the second channels 40 may thus be arranged in the electrochemically active region 18 of the separator plate 2. The first webs 32 and the second webs 42 usually form bearing surfaces for a membrane electrode assembly (MEA) 10 or the gas diffusion layer (GDL) 16 thereof, for example the MEA 10 and GDL 16 shown in FIGS. 2-3. For further details regarding the MEA 10 and the GDL 16, reference may be made to what has been stated above in relation to FIGS. 2-3. The MEA 10 and the GDL 16 are usually arranged between adjacent separator plates 2. It can also be seen in FIGS. 4A-4E and 5A-5E that the webs 32, 42 are cooled on the rear side. The regions 32, 42 of the individual plates 2a, 2b, e.g. where the electrochemical reactions take place and which require cooling, are in contact with cooling fluid on their rear sides. The individual plates 2a, 2b may be spaced apart from each other by at most 0.25 mm in the region of the webs 32, 42, so that sufficient cooling fluid is available there in the coolant chamber 19. The height of the coolant chamber 19 is thus 8-25% of the plate thickness h2.

The portion with the wave-like course of the channels 30, 40 often extends over at least part or over an entire width of the electrochemically active region 18. As an alternative or in addition, it may be provided that the wave-like course extends over at least part or over an entire length of the electrochemically active region 18.

The first individual plate 2a and the second individual plate 2b may each have a plate body made of a metal, wherein the first channels 30 and the second channels 40 are integrally formed in the respective plate body, such as by embossing. The integral forming may take place by means of hydroforming, deep-drawing or embossing, such as roller embossing or vertical embossing. The present design of the active region 18 allows the use of very thin metal sheets for fuel cells; by way of example, these may have a material thickness of ≤100 μm, ≤80 μm, ≤75 μm, ≤60 μm or even ≤50 μm.

It may be provided that the separator plate 2, in the flat surface plane of the separator plate 2, has rotational symmetry of 180°, at least outside of the electrochemically active region 18, but the entire plate may have rotational symmetry of 180°. It is also possible to make the electrochemically active region mirror-symmetrical with respect to a plane perpendicular to the main direction of extension of the channels 30, 40, and to make the remaining regions have rotational symmetry of 180°. As a result, structurally identical separator plates 2 can be used in the stack 6, with adjacent separator plates 2 being rotated 180°.

It should be noted here that, in the present specification, the channels 30, 40 are located on the open side 33, 43 of the respective individual plate 2a, 2b, while the grooves 36, 46 are arranged on the side 35, 45 opposite the open side 33, 43, e.g. on the side facing towards the cavity 19. The different terms used for the “channels” and “grooves” are selected here so as to be better able to distinguish between the different structures. Inherently, the grooves 36, 46 can also be referred to as channels, for example if they are designed to guide cooling fluid. Conversely, the channels 30, 40 can also be interpreted as grooves. The same applies to the webs 32, 42, which can be interpreted as elongated elevations, and to the elevations 34, 44, which can also be interpreted as webs.

An arrangement for an electrochemical system 1 is also proposed. The arrangement comprises a plurality of separator plates 2 of the type described here and may be designed for example as a stack 6, as shown in FIG. 1. The separator plates may have rotational symmetry of 180°. As a result, wave shapes of stacked separator plates 2 located one above the other can be offset with respect to each other, which can lead to a better distribution of forces in the stack 6. On the other hand, the separator plates 2 may be mirror-symmetrical in the electrochemically active region 18. Together with a rotationally symmetrical design of the outer regions, this enables the separator plates to be installed in a manner rotated 180° with respect to each other such that the channels and webs in individual plates located closest to each other, e.g. arranged on each side of the same MEA, have wave shapes running in phase, which may lead to the MEA being well-supported due to the linear contact.

It will be understood that features of the embodiments described above can be claimed individually or in combination with each other, provided that they do not contradict each other.

FIGS. 1-6D are shown approximately to scale. FIGS. 1-6D show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, comprising a first individual plate and a second individual plate connected to the first individual plate,
wherein the first individual plate has first channels for guiding media, which first channels are integrally formed in the first individual plate, extend next to each other, and are separated from each other by first webs formed between the first channels,
wherein the first channels form an open side and first elevations on a side of the first individual plate that is located opposite the open side, wherein the first webs form first grooves on the side of the first individual plate that is located opposite the open side of the first channels,
wherein the second individual plate has second channels for guiding media, which second channels are integrally formed in the second individual plate, extend next to each other, and are separated from each other by second webs formed between the second channels,
wherein the second channels form an open side and second elevations on a side of the second individual plate that is located opposite the open side, wherein the second webs form second grooves on the side of the second individual plate that is located opposite the open side of the second channels,
wherein the first channels and the second channels each have a wave-like course at least in part along the direction of extension thereof, wherein the wave-like course of the first channels is offset substantially by x−½ periods in relation to the wave-like course of the second channels, x being a natural number greater than 0, so that the wave shapes of the first channels and of the second channels run inversely,
wherein projections of the first channels onto the second individual plate perpendicular to a flat surface plane of the second individual plate cross the second channels along a plurality of crossing regions,
wherein the first channels have, in the crossing regions, raised channel bottom portions which receive the second elevations of the second channels,
wherein the first channels have channel bottom depressions so that the first elevations partially engage in the second grooves of the second individual plate, so that the first elevations and the second grooves are nested in each other and/or the first grooves and the second elevations are nested in each other, the two individual plates engage in each other and bear against each other at least at one side.

2. The separator plate according to claim 1, wherein the two individual plates engage in each other with a form fit.

3. The separator plate according to claim 1, wherein the first channels extend at least in part parallel to each other, and/or wherein the second channels extend at least in part parallel to each other.

4. The separator plate according to claim 1, wherein the first channels and the second channels have main directions of extension which are oriented parallel to the respective flat surface plane and parallel to each other.

5. The separator plate according to claim 2, wherein the form fit acts parallel to the flat surface planes of the individual plates and prevents any displacement of the individual plates parallel to the flat surface planes.

6. The separator plate according to claim 5, wherein the two individual plates bear against each other at least at two sides, thereby preventing any displacement of the individual plates relative to each other in at least two directions.

7. The separator plate according to claim 1, wherein the first channels and/or the second channels have an at least partially bent and/or at least partially curved cross-section transverse to the wave-like course.

8. The separator plate according to claim 1, wherein the two individual plates touch each other at contact areas, wherein at least one of the individual plates, in the region of the contact areas, is partially laser surface-treated or has a coating to improve the electrical conductivity.

9. The separator plate according to claim 1, wherein a height of the separator plate, measured perpendicular to a flat surface plane of the separator plate, is less than the sum of the material thicknesses of the two individual plates and twice the maximum channel bottom depth.

10. The separator plate according to claim 1, wherein the first channels and the second channels are arranged in an electrochemically active region of the separator plate, wherein the first webs and the second webs form bearing surfaces for a membrane electrode assembly.

11. The separator plate according to claim 10, wherein the first webs and the second webs form bearing surfaces for the gas diffusion layer.

12. The separator plate according to claim 1, wherein the first individual plate and the second individual plate each have a plate body made of a metal, wherein the first channels and the second channels are integrally formed in the respective plate body.

13. The separator plate according to claim 12, wherein the first channels and the second channels are formed by embossing.

14. The separator plate according to claim 1, wherein at least part of the separator plate has rotational symmetry of 180° in the flat surface plane of the separator plate.

15. An arrangement for an electrochemical system, comprising a plurality of separator plates according to claim 14, wherein adjacent separator plates are rotated 180° relative to each other.
